(19) United States
(12) Patent Application Publication
(10) Pub. No.: US 2024/0221629 A1
(43) Pub. Date: Jul. 4, 2024

(54) MICRO DISPLAY BACK PLANE SYSTEM AND PIXEL DRIVER CONTROLLER

(71) Applicant: JADE BIRD DISPLAY (SHANGHAI) LIMITED, SHANGHAI (CN)

(72) Inventors: Qiming LI, Shanghai (CN); Jing JU, Shanghai (CN); Hongyun LIU, Shanghai (CN); Chunming LI, Shanghai (CN)

(21) Appl. No.: 18/605,863

(22) Filed: Mar. 15, 2024

Related U.S. Application Data
(63) Continuation of application No. PCT/CN2021/119267, filed on Sep. 18, 2021.

(51) Int. Cl. G09G 3/32; G09G 3/20

(52) U.S. Cl. CPC G09G 3/32; G09G 3/2007; G09G 2320/041; G09G 2330/02; G09G 2330/12; G09G 2340/00; G09G 2360/12; G09G 2360/18

(57) ABSTRACT

A micro display back plane system includes a data interface configured to provide image data as frame data, a display frame buffer coupled to the data interface to receive the frame data from the data interface frame by frame, a column driver coupled to the display frame buffer to receive the frame data, and a pixel driver controller array coupled the column driver and configured to control pixels of a pixel display according to the frame data.

### CROSS-REFERENCE TO RELATED APPLICATION

This is a continuation application of International Application No. PCT/CN/2021/119267, filed Sep. 18, 2021.

### DESCRIPTION

### Technology Field

The disclosure relates to a micro display system including a pixel driver controller array and a micro display back plane system.

### Background

A light emitting diode (LED), which is a kind of semiconductor diode, can convert electrical energy into optical energy, and emit light in a different gray scale depending on a material of a light emitting layer included in the LED.

Digital display technology has become one of the largest branches in the field of modern electronics and optoelectronics and generates demands in various applications where an image forming function is needed. Among those applications, a micro-LED display, which has the potential of generating an image with better contrast, within shorter response times, with more energy efficiency, and with higher refresh rate is of interest.

Nowadays, wearable devices, including smart wearable devices, sometimes require a mini display screen on the device. Compared to traditional electronic devices having a screen, these smart wearable devices (such as, a smart watch, a smart phone, an augmented reality headset, etc.) require the screen to be smaller in size, to respond to a user's control more quickly, to use as little energy as possible, and to provide a higher refresh rate so that the device does not emit excessive heat, can last longer, and can produce better quality images. Therefore, a high-contrast, quick-response, energy-efficient, and higher refresh rate screen for wearable devices is in demand.

In an LED system, a back plane and power source combination determines size, brightness and contrast, and energy efficiency of the LED system. In a conventional LED system, the back plane and power source combination is bulky and introduces energy loss into the system, which may cause the LED system to not provide sufficient brightness and contrast or refresh rate. Such a system is not suitable for wearable devices because of these deficiencies. An improved LED system for wearable devices is needed.

### SUMMARY

In accordance with the present disclosure, there is provided a micro display back plane system. The system includes a data interface configured to provide image as frame data; a display frame buffer coupled to the data interface to receive the frame data from the data interface frame by frame; a column driver; and a pixel driver controller array coupled to the column driver and configured to control pixel of a pixel display according to the frame data.

Also in accordance with the present disclosure, there is provided a pixel driver controller including a reference current source configured to supply a reference current; a current mirror source, coupled to receive the reference current source, configured to provide a mirror current having a current value equal to a current value of the reference current; at least two current switches, each coupled to the current mirror source to receive the mirror current, each current switch being further coupled to an LED device to control flow of the mirror current to the LED device.

Further in accordance with the present disclosure, there is provided a pixel driver controller includes a reference current source configured to supply a reference current, at least two current mirror circuits, each of the current mirror circuits includes a current mirror source and a current switch, the current mirror source coupled in series to the current switch, wherein the current mirror sources are configured to have respectively different current values; and each of the current switches is configured to control a power-on and power-off status of the corresponding current mirror circuit according to frame data; each current mirror circuit being further coupled to an LED device to control flow of the mirror current to the LED device.

Additionally in accordance with the present disclosure, there is provided a micro display back plane system including a data interface, configured to provide image data as frame data; a display frame buffer, coupled to the data interface to receive the frame data from the data interface frame by frame; a column driver coupled to the display frame buffer to receive the frame data; and a pixel driver controller array coupled to the column driver and configured to control pixels of a pixel display according to the frame data. At least one pixel driver controller of the pixel driver controller array includes a reference current source, configured to supply a reference current; a current mirror source, coupled to receive the reference current source, configured to provide a mirror current having a current value equal to a current value of the reference current; and at least two current switches, each coupled to the current mirror source to receive the mirror current, each current switch being further coupled to an LED device to control flow of the mirror current to the LED device.

Also in accordance with the present disclosure, there is provided a micro display back plane system including a data interface, configured to provide image data as frame data; a display frame buffer coupled to the data interface to receive the frame data from the data interface frame by frame; a column driver coupled to the display frame buffer to receive the frame data; and a pixel driver controller array which is coupled to the column driver and configured to control pixels of a pixel display according to the frame data. At least one pixel driver controller of the pixel driver controller array further includes a reference current source, configured to supply a reference current; at least two current mirror circuits, each of the current mirror circuits comprising; a current mirror source and a current switch, the current mirror source coupled in series to the current switch; wherein the current mirror sources are configured to have respectively different current values; and each of the current switches is configured to control a power-on and power-off status of the corresponding current mirror circuit according to frame data; and each current mirror circuit being further coupled to an LED device to control flow of the mirror current to the LED device.

### BRIEF DESCRIPTION OF THE DRAWINGS

FIG. 1 is a schematic block diagram of an exemplary micro display back plane system for an LED display device, according to an exemplary embodiment of the present disclosure.

FIG. 2 is a schematic block diagram of a pixel driver controller of the micro display back plane system, according to an exemplary embodiment of the present disclosure.

FIG. 3 is a schematic block diagram of components of a pixel driver controller of the micro display back plane system, according to another exemplary embodiment of the present disclosure.

### DESCRIPTION OF THE EMBODIMENTS

Hereinafter, embodiments consistent with the disclosure will be described with reference to the drawings. Wherever possible, the same reference numbers will be used throughout the drawings to refer to the same or like parts.

As discussed above, a conventional LED back plane system for wearable devices is bulky and introduces energy loss into LED systems. As a result, the conventional LED back plane system is not suitable for wearable devices because a wearable device requires the system to be relatively small in size, to produce sufficient brightness and contrast for a user, to be energy efficient, and to provide a sufficient refresh-rate for the screen.

Consistent with embodiments of the present disclosure, a micro LED back plane system includes an LED array suitable for wearable devices and a combination of a reference current source and a current mirror source configured to supply steady power to the LED system. This ensures the micro LED display system can be smaller in size, produce steady light with sufficient brightness and contrast, be energy efficient, and provide a sufficient refresh-rate for the screen.

Some embodiments consistent with the present disclosure include a micro display back plane system, including a data interface, an image processing module, a pixel driving controller array, a row driver, a power controller, and at least one sensor. The image processing module includes a display frame buffer, a column driver, and a one-time programmable (“OTP”) memory. Some embodiments consistent with the present disclosure include a reference current source, a current mirror source, at least two current switches, an LED device, an internal memory, a global brightness controller unit, a test circuit, and a shared electrode. Some embodiments consistent with the present disclosure include a reference current source, at least two current mirror circuits, an LED device, an internal memory, a global brightness controller unit, a test circuit, and a shared electrode. The micro display back plane systems consistent with disclosed embodiments are capable of overcoming the drawbacks of conventional micro display back plane systems, including micro LED back plane systems.

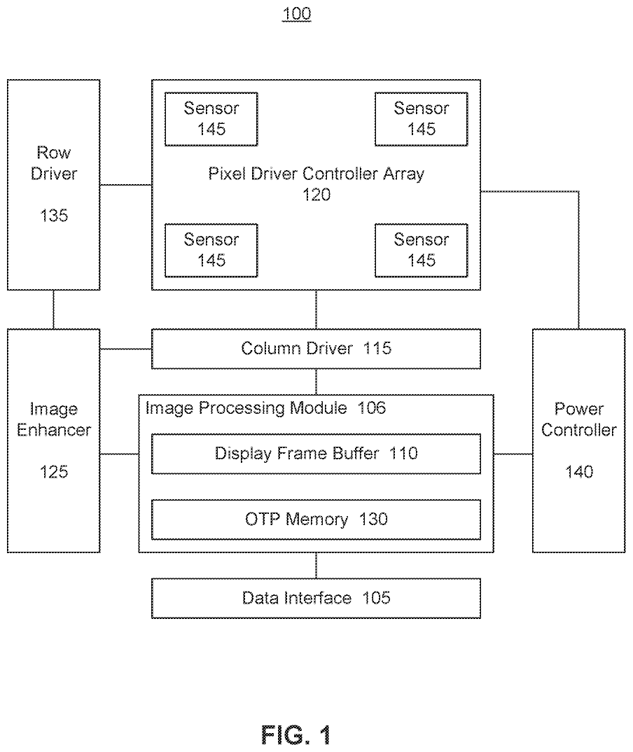

FIG. 1 is a schematic block diagram of an exemplary micro display back plane system 100 for an LED display device consistent with embodiments of the present disclosure. The micro display back plane system 100 includes a data interface 105. In some embodiments, the data interface 105 can be provided as an information exchange component that may be installed software, internal hardware, or a peripheral device. The micro display back plane system 100 also includes an image processing module 106. The image processing module 106 includes a display frame buffer 110 and a one-time-programmable (“OTP”) memory 130. The display frame buffer 110 of the image processing module 106 is coupled to the data interface 105. In some embodiments, the display frame buffer 110 is provided as random-access memory (“RAM”) of the micro display back plane system 100. The OTP memory 130 of the image processing module 106 is also coupled to the data interface 105. In some embodiments, the OTP memory 130 is provided as a non-volatile memory that can only be programmed once. In some embodiment, the OTP memory 130 stores programs for performing image processing.

The micro display back plane system 100 further includes an image enhancer 125 coupled to the image processing module 106. In some embodiments, the image enhancer 125 can be provided as a circuit, a chip, a microchip, or other electronic components or devices that is configurable to enhance digital image data by processing original digital image data, such as frame data, and producing optimized image data using one or more specific algorithms and parameters obtained from the OTP memory 130. In some embodiments, the image enhancer 125 is implemented as software executed on a processor included in image enhancer 125, which is capable of performing the image data enhancement. In some embodiments, the image enhancer 125 is a graphic processing unit (“GPU”).

The micro display back plane system 100 also includes a column driver 115 coupled to the image enhancer 125. In some embodiments, the column driver 115 comprises drivers provided as one or more sets of integrated LED circuits, chips, or microchips. The micro display back plane system 100 also includes a row driver 135. The row driver 135 is also coupled to the image enhancer 125. In some embodiments, the row driver 135 comprises drivers provided as one or more sets of integrated LED circuits, chips, or microchips.

The micro display back plane system 100 further includes a pixel driver controller array 120 coupled to the column driver 115 and the row driver 135. In some embodiments, the pixel driver controller array 120 can be provided as a circuit, a chip, a microchip, or other electronic components or devices configurable to control pixels of an LED display.

The micro display back plane system 100 further includes a power controller 140 coupled to the image processing unit 106, the column driver 115, and the pixel driver controller array 120. In some embodiments, the power controller 140 can be provided as a switch, a circuit, a chip, a microchip, a current source, or other electronic components or devices configurable to control power for the back plane system 100.

The micro display back plane system 100 further includes one or more sensors 145 coupled to the pixel driver controller array 120. In some embodiments, the one or more sensors 145 include a temperature sensor configured to detect temperature of the pixel driver controller array 120. More specifically, each of the one or more sensors 145 detects and monitors temperature of the pixel driver controller array 120 and provides the detected temperature value to a general purpose computer that the micro display back plane system 100 is coupled to, so that the general purpose computer can shut down power to the back plane system 100 if the temperature of the pixel driver controller array reaches a threshold value, such as 80 degree Celsius, or any temperature preset by the user, the manufacture, or that meets industrial standards of LED system manufacture.

Consistent with the present disclosure, the data interface 105 is configured to receive and provide data for the back plane system 100. Specifically, the data interface 105 provides raw image data it receives to the image processing module 106.

In some embodiments, the data interface 105 receives image data input from an image data providing electronic device inside or outside of the system 100. For example, the data interface 105 may receive raw image data, pre-processed frame data, or both, from a ROM, a hard drive, or from a peripheral device such as a camera, a video recording device, a portable driver, a USB driver, a touch screen, or other device generating raw image data. The raw image data can be raster graphics data, vector image data, video data, or other forms of image data that are currently, or may become, available. In some embodiments, the data interface 105 connects with an external data-providing device through a physical connection, such as through an electronic cable. In some embodiments, the data interface 105 connects with the peripheral device wirelessly, such as through a Wi-Fi or a BLUETOOTH™ connection. In some embodiments, the data interface 105 processes the received raw image data to produce sets of corresponding frame data. In some embodiments, the data interface 105 storing decoding software and a processor that executes the software to process the raw image data. In some embodiments, the data interface 105 further includes decoding hardware, e.g., one or more ASICs or graphics processors, to process the raw image data. More specifically, when the image data is in video format, the data interface 105, through decoding software/hardware, samples the video format image data, e.g., using a periodic sampling method, and creates sets of graphic format data. In some embodiment, the sampling interval is equal to or less than 1/24 second. In some embodiments, the sampling method can be interpolation, polling, convolution, deconvolution, or other methods of video format image data sampling that are currently, or may become, available. More specifically, when the raw image data is vector graphic data, the decoding software/hardware converts the sets of vector graphic data into sets of raster graphic image data, or an LED-display-friendly dot matrix data structure that is currently, or may become, available. The data interface 105 further transmits the frame data to the image processing module 106.

More particularly, in some embodiments, the display frame buffer 110 of the image processing module 106 receives frame data from the data interface 105 one frame at a time. In some embodiments, the display frame buffer 110 receives the frame data in chronological order. In some other embodiments, the display frame buffer 110 receives the frame data in the order that the frame data is stored in a storage medium connected to the data interface 105. More specifically, the frame data received by the image processing module 106 can be frame data converted from raw image data by the data interface 105, or image data received by the data interface 105 already in frame data format. In some embodiments, the data interface 105 directly connects to the display frame buffer 110.

Still with reference to FIG. 1, in some embodiments, the data interface 105 transmits the frame data to the frame buffer 110 and to the OTP memory 130 at the same time. The OTP memory 130 is configured to provide a compensation value for the frame data. In some embodiment, the compensation value is a set of parameters stored in the OTP memory 130, for accentuating or sharpening image features. The image enhancer 125 is coupled to the OTP memory 130 and receives the compensation value provided by the OTP memory 130. The image enhancer 125 is configured to process the frame data received from the image processing module 106. In some embodiments, the image enhancer 125 includes a processor and the OTP memory 130 stores an executable computer program that can be executed by the image enhancer 125 to determine the compensation value. In some embodiments, the programming causes the image enhancer 125 to accentuate, or sharpen, image features of the image represented by the raw image data, such as edges of a specific shape in the image, boundaries between different areas in the image, or color contrast, not only to restore lost graphical information and remove graphical noise created during the process of converting raw data to frame data, but also to format the graphic display to be more suitable for LED display.

The OTP memory 130 of the image processing module 106 is coupled to the image enhancer 125 and to the data interface 105. In some embodiments, the data interface 105 transmits LED-display-friendly frame data to the display frame buffer 110, and at the same time, the data interface 105 transmits both the raw image data and frame data to the OTP memory 130. As used herein, the raw image data is also referred to as standard image data. In some embodiments, the OTP memory 130 stores one or more image processing programs that can be executed by a processor of the image enhancer 125 to calculate the compensation value based on comparing the raw image data, such as rich-information raster data or a vector image, to the frame data. Specifically, the OTP memory 130 stores one or more programs that can be executed by the processor of the image enhancer 125 to process a raster image pixel-by-pixel or process a vector image by areas and boundaries. In some embodiments, the OTP memory 130 outputs a compensation value to enhance or to refine the frame image data so that the frame data can be more suitable for LED display. In some embodiments, the OTP memory 130 calculates the compensation value based on the frame data stored in the display frame buffer 110 and the raw video image data captured or received by the data interface 105. When raw data of a video clip is processed by the data interface 105, some image features may be lost during the decoding process of decoding the video clip into a series of discrete frame data. The raw image data transmitted to the OTP memory has more detail, such as color, contrast, and brightness. The raw image usually is large in size and cannot be displayed directly on an LED display. By comparing the stored frame data of the video clip to the raw image data, the OTP memory 130 calculates a compensation value to enhance the image represented by the frame data, so that the frame data can better represent the features in the raw image data, when displayed on the LED display.

The image enhancer 125 combines the frame data stored in the frame buffer 110 with the compensation value provided by the OTP memory 130, and produces optimized frame data to transmit to the column driver 115. In some embodiments, the compensation value calculated by the OTP memory 130 is a compensation value matrix. In some embodiments, the compensation value is a preset value previously stored in the OTP memory 130. In some embodiments, the image enhancer 125 produces the optimized frame data by processing the frame data pixel by pixel. The processing by the image enhancer 125, in some embodiments, includes adding or subtracting certain values to the specific pixel according to the compensation value matrix.

In some embodiments, the display frame buffer 110 is coupled between the image enhancer 125 and the column driver 115. The display frame buffer 110 transmits the optimized frame data it received from the image enhancer 125 to the column driver 115. In some embodiments, the image enhancer 125 is coupled to the column driver 115 and directly transmits the optimized frame data to the column driver 115. In some embodiments, the image enhancer 125 is also coupled to the row driver 135 and directly transmits the optimized frame data to the row driver 135.

Consistent with the present disclosure, the column driver 115, being coupled to the pixel driver controller array 120, controls image display by controlling pixel scanning by column. The row driver 135, being coupled to the pixel driver controller array 120, controls the image display by controlling pixel scanning by row.

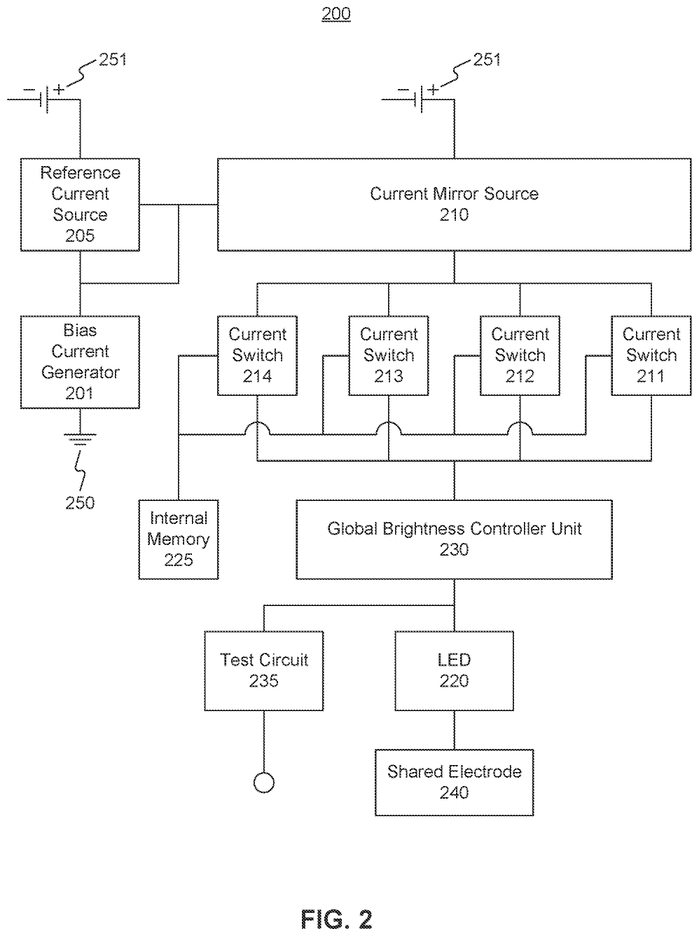

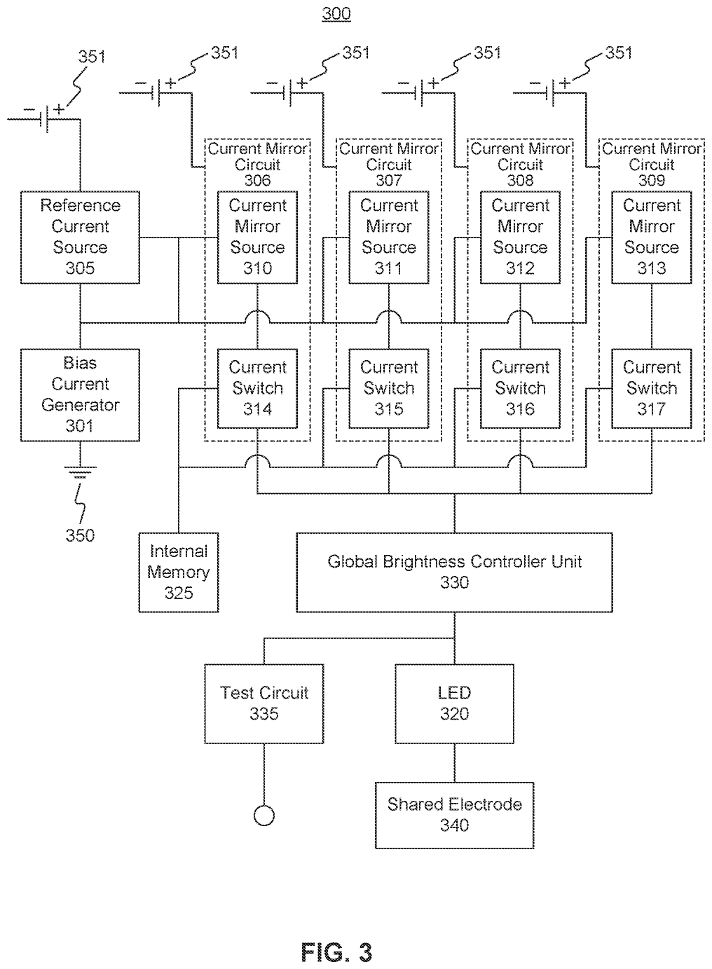

The pixel driver controller array 120 receives frame data from the column driver 115 and the row driver 135, together or separately. In some embodiments, the pixel driver controller array 120 is an integrated LED circuit. In some embodiment, the pixel driver controller array 120 comprises at least one pixel driver controller 200 or 300, as respectively depicted in FIGS. 2 and 3 and described more fully below.

FIG. 2 is a schematic block diagram of components of the exemplary pixel driver controller 200, consistent with embodiments of the present disclosure. The pixel driver controller 200 receives power from at least an external voltage reference, e.g., ground, 250 that is coupled to a bias current generator 201. The pixel driver controller 200 also receives power from at least one external direct current power supply 251 that is coupled to a reference current source 205 and a current mirror source 210. The pixel driver controller 200 includes the bias current generator 201. In some embodiments, the bias current generator 201 is provided as a power generator that produces a fixed DC voltage or current for operating the pixel driver controller 200. In some embodiments, the bias current generator 201 can be external to the pixel driver controller 200. The pixel driver controller 200 includes the reference current source 205 that provides a reference current that is stable and does not fluctuate with temperature, supply voltages, or loads. The reference current source 205 provides the reference current for operation of the pixel driver controller 200. The pixel driver controller 200 also includes the current mirror source 210 that generates a mirror current that is a copy of the reference current. The current mirror source 210 controls the current in an LED device 220 and maintains an output mirror current of the current mirror source 210 constant, regardless of loading. The current mirror source 210 is coupled to receive the reference current provided by the reference current source 205.

The pixel driver controller 200 also includes at least two current switches. In the present embodiment, the pixel driver controller includes four switches 211, 212, 213, and 214. Each of the current switches 211-214 is configured to control the “on” and “off” status of a circuit.

The pixel driver controller 200 also includes an internal memory 225 provided as an internal memory chip or circuit. The internal memory 225 is used to store frame data that the pixel driver controller 200 receives, for example, from either column driver 115 or row driver 135, or from both. In the embodiment depicted in FIG. 2, each of the current switches 211, 212, 213 or 214 is connected with the internal memory 225.

The pixel driver controller 200 also includes a global brightness controller unit 230. In some embodiment, the global brightness controller 230 is provided as a current controller that is configured to receive the constant mirror current and control the current in the LED device 220, so as to control the brightness of the LED device 220. The global brightness controller 230 is coupled to each of the current switches 211, 212, 213 and 214, and adjusts a gray scale value of the LED device 220. In some embodiments, the gray scale value of the LED device 220 can be an RGB color scale value. A typical LED device 220 that is capable of emitting color includes at least two light-emitting units, such as micro LED light bulbs. Each micro LED light bulb emits a single colored light such as red, green, or blue. In some embodiments, the LED device 220 also includes an optical combining unit that combines the single colored light-emitting micro LED's light and presents a colored light on the LED device 220.

The pixel driver controller 200 also includes a test circuit 235 that is configured to test the current and voltage stability of the pixel driver controller 200.

The pixel driver controller 200 also includes a shared electrode 240 provided as a conductor that is used to make contact with a circuit. In some embodiments, the shared electrode 240 is configured to enable multiple pixel driver controllers 200 to be electrically connected through their respective shared electrodes 240 and form the pixel driver controller array 120 illustrated in FIG. 1. In some embodiments, each pixel driver controller 200 of the pixel driver controller array 120 is configured to control its corresponding LED device 220. The LED device 220 is further configured so that multiple LED devices 220 can be formed as a master LED device. Accordingly, the display of the master LED device is controlled by the pixel driver controller array 120.

In some embodiments, the bias current generator 201 provides a stable current at a specified electric potential. In some embodiments consistent with FIG. 2, the reference current source 205 and the current mirror source 210 are in the same integrated circuit and the reference current value is equal to the mirror current value. In the embodiment depicted in FIG. 2, the current mirror source 210 connects to the four current switches 211, 212, 213, and 214. The current switches 211, 212, 213, and 214 are together coupled in parallel to the current mirror source 210 and are coupled to and control the power-on and power-off status of the LED device 220 according to frame data the pixel driver controller 200 receives. In some embodiments, the shared electrode 240 is configured to make contact with an external power source and configured to receive the p-type junctions of at least one LED device 220.

In some embodiments, the power-on status of each current switch 211, 212, 213, or 214, is determined by a gray scale value that is determined by the frame data that pixel driver controller 200 receives from the row driver 135 or the column driver 115 and stores in the internal memory 225. In some embodiments, the gray scale value of the LED device 220 can be an RGB color scale value. Thus, the display of the LED device 220 coupled to the pixel driver controller 200 is further determined by the power-on status of each of the current switches 211, 212, 213, and 214.

For illustrative purposes to facilitate description, and without limitation, the gray scale value ranges from 1 bit to 8 bits. In some embodiments, the gray scale value of the frame data received by the pixel driver controller 200 is an integer multiple of the number of the current switches. In some embodiments, the gray scale value is 8 bits and the number of the current switches is j, where j is an integer. The value of j is defined by the following equation:

$$j = 8 / m , where m is a preset value that is 1 , 2 , 4 , or 8.$$

In some embodiments, the display of the LED device 220 is determined by a power-on time ratio, also referred to as a duty-ratio, of each pixel and the LED device 220 that is controlled by the pixel driver controller 200. Consistent to the number “j” of the current switches, in some embodiments, the power-on time ratio of the pixel is defined by the following equation:

$${2}^{( j - 1 )} : {2}^{( j - 2 )} : … : {2}^{0} , when j , the number of the current switches , is larger than 2 ; \\ {2}^{( j - 1 )} : {2}^{0} , when j is 2.$$

In some embodiments, the gray scale value is 8 bits, m is 2, and the number of switches j is defined by the equation: j=8/m, so that j is 4. As such, the power-on time ratio, or duty-ratio, of each switch is:

$${2}^{( 4 - 1 )} : {2}^{( 4 - 2 )} : {2}^{( 4 - 3 )} : {2}^{( 4 - 4 )} = 8 : 4 : 2 : 1.$$

In this specific embodiment, the on-duty period of the current switch 211 is 8 times the on-duty period of the current switch 214, the on-duty period of the current switch 213 is 4 times the on-duty period of the current switch 214, and the on-duty period of the current switch 212 is double the on-duty period of the current switch 214. As such, specific gray scale values or color scale values can be displayed on the LED device 220. Further according to this embodiment, an LED screen that includes multiple LED devices 220 can display an optimized gray scale or color scale image.

In some embodiments, the gray scale value is 8 bits, m is 4, and the number of switches j is defined by the equation: j=8/m, so that j is 2. As such, the power-on time ratio, or the duty-ratio, of each switch is:

$${2}^{( 2 - 1 )} : {2}^{( 2 - 2 )} = 2 : 1.$$

In this specific embodiment, the on-duty period of the current switch 211 is double the on-duty period of the current switch 214, and the current switches 212 and 213 are disabled. Further according to this embodiment, an LED screen that includes multiple LED devices 220 can display an optimized gray scale or color scale image.

In some embodiments, the global brightness controller 230 increases the brightness of the LED device 220 when the brightness of the frame data is below a threshold and the contrast of the frame data is not sufficient for proper display. In some embodiments, the global brightness controller dims the display of the LED device 220 when the brightness of the frame data exceeds a threshold and the contrast of the frame data is not properly displayed. In some embodiments, the test circuit 235 is coupled to the global brightness controller unit 230 and the LED device 220. The test circuit 235 tests the brightness of the LED device 220 and feeds back the brightness test result to the global brightness controller unit 230 to adjust the brightness of the LED device 220.

In some embodiments, multiple pixel driver controllers 200 depicted in FIG. 2 can be configured to form the pixel driver controller array 120 depicted in FIG. 1.

FIG. 3 is a schematic block diagram of components of the exemplary pixel driver controller 300, consistent with embodiments of the present disclosure. The pixel driver controller 300 receives power from an external voltage reference, e.g., ground, 350 that is coupled to a bias current generator 301. The pixel driver controller 300 also receives direct current power from at least one external power supply 351 that is coupled to a reference current source 305, and current mirror circuits 306, 307, 308, and 309. The pixel driver controller 300 includes a bias current generator 301. In some embodiments, the bias current generator 301 is provided as a power generator that produces a fixed DC voltage or current for operating the pixel driver controller 300. In some embodiments, the bias current generator 301 can be external to the pixel driver controller 300. The pixel driver controller 300 includes a reference current source 305 that provides a reference current, a current that is stable and does not fluctuate with temperature, supply voltages, or loads. The reference current source 305 provides the reference current of the pixel driver controller 300.

The pixel driver controller 300 also includes current mirror circuits 306, 307, 308, and 309. The current mirror circuits 306, 307, 308, and 309 respectively include current mirror sources 310, 311, 312, and 313, that each generate a mirror current that is different in value. Each of the current mirror sources 310, 311, 312, and 313 controls the current in an LED device 320 and maintains an output current of the current mirror sources 310, 311, 312, and 313 independent and constant, regardless of loading. Although the current mirror sources 310, 311, 312, and 313 are coupled to receive the reference current provided by the reference current source 305, the current mirror current of the respective current mirror sources 310-313 are different from each other. In some embodiments, one or more of the current mirror sources 310, 311, 312, and 313 are configured to amplify the reference current of the reference current source 305, some others of the current mirror sources 310-313 are configured to reduce the reference current of the reference current source 305, and the rest of the current mirror sources 310-313 are configured to copy the reference current of the reference current source 305. In some embodiments, a transistor gate of each of the current mirror sources 310, 311, 312, and 313 connects with a transistor gate of the reference current source 305. In some embodiments, a transistor drain of the reference current source 305 connects with the transistor gate of the reference current source 305. In some embodiments, the transistor drain of the reference current source 305 is configured to be the source of and provide electric power to the current mirror sources 310, 311, 312, and 313. When the transistor gate of each of the current mirror sources 310, 311, 312, and 313 is in the power-on status, electricity flows directly from the transistor drain of the reference current source 305 to the transistor gate of the current mirror sources 310, 311, 312, and 313, so that it decreases drain-to-source bias. The current mirror circuits 306, 307, 308, and 309 also respectively includes current switches 314, 315, 316, and 317, that are correspondingly coupled to the current mirror sources 310, 311, 312, and 313. Each of the current switches 314-317 is configured to control the “on” and “off” status of a circuit. In some embodiments as illustrated in FIG. 3, the current mirror sources 310, 311, 312, and 313 are each coupled with a corresponding one of the current switches 314, 315, 316, and 317.

The pixel driver controller 300 also includes an internal memory 325 provided as an internal memory chip or circuit. The internal memory 325 is used to store frame data that the pixel driver controller 300 receives, for example, from either column driver 115 or row driver 135, or from both. In the embodiment depict in FIG. 3, each of the current switches 314, 315, 316, and 317 is connected with the internal memory 325.

The pixel driver controller 300 also includes a global brightness controller unit 330. In some embodiments, the global brightness controller 330 is provided as a current controller configured to control the current in the LED device 320, so as to control the brightness of the LED device 320. The global brightness controller 330 is coupled to each of the current switches 314, 315, 316 and 317, and adjusts the gray scale, or color scale, value of the LED device 320.

The pixel driver controller 300 also includes a test circuit 335 that is configured to test the current and voltage stability of the pixel driver controller 300.

The pixel driver controller 300 also includes a shared electrode 340 provided as a conductor that is used to make contact with a circuit. In some embodiments, the shared electrode 340 is configured to enable multiple pixel driver controllers 300 to be electrically connected through their respective shared electrodes 340 and form the pixel driver controller array 120 illustrated in FIG. 1. In some embodiments, each pixel driver controller 300 of the pixel driver controller array 120 is configured to control its corresponding LED device 320. The LED device 320 is further configured so that multiple LED device 320 can be formed as a master LED device. Accordingly, the display of the master LED device is controlled by the pixel driver controller array 120.

In some embodiments, the bias current generator 301 provides a stable current at a specified electric potential. In some embodiments consistent with FIG. 3, the reference current source 305 and the current mirror sources 310, 311, 312, 313 are in the same integrated circuit and the reference current value equals to the mirror current value. In some embodiments consistent with FIG. 3, the current mirror sources 310, 311, 312, and 313 are each configured to amplify the current value of the reference current source 305. More specifically, the current mirror source 310, 311, 312, and 313 are configured to increase output current by decreasing output resistance or increasing drain-to-source voltage, through known semiconductor designs and models that meet industrial standards of LED system manufacture. In some embodiments consistent with FIG. 3, the current mirror sources 310, 311, 312, and 313 are each configured to decrease the current value of the reference current source 305. More specifically, the current mirror sources 310, 311, 312, and 313 are configured to decrease output current by increasing output resistance or decreasing drain-to-source voltage, through known semiconductor designs and models that meets industrial standards of LED system manufacture. In some embodiments, the current value of each of current mirror sources 310, 311, 312, 313 is zero, a percentage multiple, or a positive integer multiple of the reference current, and each current mirror source 310, 311, 312 and 313 is configured to generate a different current value.

In the pixel driver controller 300, the current mirror source 310 is coupled to the current switch 314, the current mirror source 311 is coupled to the current switch 315, the current mirror source 312 is coupled to the current switch 316, and the current mirror source 313 is coupled to the current switch 317. The current mirror source and current switch combinations are together coupled in parallel to the reference current source 305 and are coupled to and control the power-on and power-off status of the LED device 320 according to frame data the pixel driver controller 300 receives and stores in internal memory 325. Although FIG. 3 illustrates four current switches, in some embodiments, the number of current switches can be two, three, or more than four, and the number of current mirror sources can be two, three, or more than four accordingly.

In some embodiments, the power-on status of each current switch 314, 315, 316, or 317, is determined by a gray scale value that is determined by the frame data that pixel driver controller 300 receives from the row driver 135 or the column driver 115 and stores in internal memory 325. Thus, the display of the LED device 320 coupled to the pixel driver controller 300 is further determined by the power-on status of each of the current switches 314, 315, 316, and 317.

For illustrative purpose to facilitate description, and without limitation, the gray scale value ranges from 1 bit to 8 bits. In some embodiments, the gray scale value of the frame data received by the pixel driver controller 300 is an integer multiple of the number of the current switches. In some embodiments, the gray scale value is 8 bits and the number of the current switches is j, where j is an integer. The value of j is defined by the following equation:

$$j = 8 / m , where m is a preset value that is 1 , 2 , 4 , or 8.$$

In some embodiments, m is the gray scale value.

In some embodiments, the display of the LED device 320 is determined by the power-on time ratio, also referred to as the duty-ratio, of each pixel and the LED device 320 that is controlled by the pixel driver controller 300. Consistent to the number “j” of the current switches, in some embodiments, the power-on time ratio of the pixel is defined by the following equation:

$${2}^{( j - 1 )} : {2}^{( j - 2 )} : … : {2}^{0} , when j , the number of the current switches , is larger than 2 ; \\ {2}^{( j - 1 )} : {2}^{0} , when j is 2.$$

In some embodiments, the gray scale value is 8 bits, m is 2, the number of switches j is defined by the equation: j=8/m, so that j is 4. As such, the power-on time ratio, or duty-ratio, of each switch is:

$${2}^{( 4 - 1 )} : {2}^{( 4 - 2 )} : {2}^{( 4 - 3 )} : {2}^{( 4 - 4 )} = 8 : 4 : 2 : 1.$$

In this specific embodiment, the on-duty period of the current switch 314 is 8 times the on-duty period of the current switch 317, the on-duty period of the current switch 315 is 4 times the on-duty period of the current switch 317, and the on-duty period of the current switch 316 is double the on-duty period of the current switch 317. As such, specific gray scale values or color scale values can be displayed on the LED device 330. Further in this embodiment, an LED screen that includes multiple LED devices 330 can display an optimized gray scale or color scale image on the LED screen.

Consistent with the embodiment described above, the current values of the current mirror sources corresponding to each of the switches have values in ratios of 8:4:2:1.

In some embodiments, the gray scale value is 8 bits, m is 4, and the number of switches j is defined by the following equation: j=8/m, so that j is 2. As such, the power-on time ratio, or duty-ratio, of each switch is:

$${2}^{( 2 - 1 )} : {2}^{( 2 - 2 )} = 2 : 1.$$

In this specific embodiment, the on-duty period of the current switch 314 is double the on-duty period of the current switch 317, and the current switches 315 and 316 are disabled. As such, specific gray scale values or color scale values can be displayed on the LED device 330. Further in this embodiment, an LED screen that includes multiple LED devices 330 can display an optimized gray scale or color scale image on the LED screen.

Consistent with the embodiment described above, the current values of the current mirror sources corresponding to each of the switches have values in ratios of 2:1.

In some embodiments, the global brightness controller 330 increases the brightness of the LED device 320 when the brightness of the frame data is below a threshold and the contrast of the frame data is not sufficient for proper display. In some embodiments, the global brightness controller dims the display of the LED device 320 when the brightness of the frame data exceeds a threshold and the contrast of the frame data is not properly displayed. In some embodiments, the test circuit 335 is coupled to the global brightness controller unit 330 and the LED device 320. The test circuit 335 tests the brightness of the LED device 320 and feeds back the brightness test result to the global brightness controller unit 330 to adjust the brightness of the LED device 320.

In some embodiments, multiple pixel driver controllers 300 depicted in FIG. 3 can be configured to form the pixel driver controller array 120 depicted in FIG. 1.

Other embodiments of the disclosure will be apparent to those skilled in the art from consideration of the specification and practice of the invention disclosed herein. It is intended that the specification and examples be considered as exemplary only, with a true scope and spirit of the invention being indicated by the following claims.

We claim:

1. A micro display back plane system, comprising:
a data interface configured to provide image data as frame data;
a display frame buffer coupled to the data interface to receive the frame data from the data interface frame by frame;
a column driver coupled to the display frame buffer to receive the frame data; and
a pixel driver controller array coupled the column driver and configured to control pixels of a pixel display according to the frame data.

2. The micro display back plane system according to claim 1, further comprising:
an image enhancer coupled to the display frame buffer to receive and sharpen an image represented by the frame data.

3. The micro display back plane system according to claim 2, comprising:
a one-time-programmable (“OTP”) memory coupled to the image enhancer and configured to determine a compensation value;
wherein, the image enhancer is coupled to receive the compensation value from the OTP memory and optimize the frame data by applying the compensation value to the received frame data, the image enhancer being coupled to transmit the optimized frame data to the column driver.

4. The micro display back plane system according to claim 3, wherein the OTP memory is coupled to the data interface and the display frame buffer to receive standard image data via the data interface and the frame data from the display frame buffer, the OTP memory being further configured to determine the compensation value by comparing the standard image data with the frame data received from the display frame buffer.

5. The micro display back plane system according to claim 1, comprising a power controller configured to control the system power for the back plane system.

6. The micro display back plane system according to claim 1, comprising a row driver coupled to the pixel driver controller array and configured to control row scanning of the pixels to turn pixels on or off.

7. A pixel driver controller, comprising:
a reference current source, configured to supply a reference current;
a current mirror source, coupled to receive the reference current, configured to provide a mirror current having a current value equal to a current value of the reference current;
at least two current switches, each coupled to the current mirror source to receive the mirror current, each current switch being further coupled to an LED device to control flow of the mirror current to the LED device.

8. The pixel driver controller according to claim 7, further comprising an internal memory configured to store frame data, each of the current switches being coupled to the internal memory to control operation of the current switches according to the frame data.

9. The pixel driver controller according to claim 8, wherein a power-on status of each of the current switches corresponds to a state of conducting the mirror current, the power-on status of each of the current switches being determined by a gray scale value of the frame data;
wherein, a gray scale of light emitted by the LED device is determined by the power-on status of each of the current switches.

10. The pixel driver controller according to claim 9, wherein the number of the current switches is determined by the gray scale value of the frame data, the gray scale value of the frame data being an integer multiple of the number of the current switches.

11. The pixel driver controller according to claim 9, wherein the gray scale value of the frame data is N bit, where N is a non-negative integer.

12. The pixel driver controller according to claim 11, wherein the value of N is 8, the number of the current switches is j, where j is an integer, and j=8/m, where m is a preset value that is 1, 2, 4, or 8.

13. The pixel driver controller according to claim 12, wherein a power-on time ratio of the current switches is 2^{(i-j)}:2^{(j-2)}: . . . :2⁰, when j is greater than 2, and the power-on time ratio of the current switches is 2^{(j-1)}:2⁰, when j equals to 2.

14. The pixel driver controller according to claim 9, further comprising a global brightness controller coupled to each of the current switches, to adjust the gray scale value of the LED device.

15. The pixel driver controller according to claim 14, further comprising a test circuit coupled between the LED device and the global brightness controller.

16. A pixel driver controller, comprising:
a reference current source configured to supply a reference current;
at least two current mirror circuits, each of the current mirror circuits comprising:
a current mirror source and a current switch, the current mirror source coupled in series to the current switch;
wherein the current mirror sources are configured to have respectively different current values; and each of the current switches is configured to control a power-on and power-off status of the corresponding current mirror circuit according to frame data;
each current mirror circuit being further coupled to an LED device to control flow of the mirror current to the LED device.

17. The pixel driver controller according to claim 16, further comprising an internal memory configured to store frame data, each of the current switches being coupled to the internal memory to control operation of the current switches according to the frame data.

18. The pixel driver controller according to claim 16, wherein the current value of each current mirror sources is an integer multiple of the reference current value.

19. The pixel driver controller according to claim 18, wherein the current value of each of the current mirror sources is 2n times of the reference current, where n is a non-negative integer.

20. The pixel driver controller according to claim 18, wherein the number of the current mirror sources is determined by a gray scale value of the frame data, the gray scale value of the frame data being an integer multiple of the number of the current mirror sources.

21. The pixel driver controller according to claim 18, wherein the gray scale value of the frame data is N bit, N is a non-negative integer.

22. The pixel driver controller according to claim 21, wherein the value of N is 8, the number of the current mirror sources is j, where j is an integer, and j=8/m, where m is a preset value that is 1, 2, or 4.

23. The pixel driver controller according to claim 22, wherein a current value ratio of the current mirror source is 2^{(j-1)}:2^{(j-2)}: . . . :2⁰, when j is larger than 2; and the current value ratio of the current mirror source is 2^{(j-1)}:2⁰, when j is 2.

24. The pixel driver controller according to claim 16, wherein a transistor gate of each of the current mirror sources is coupled to a transistor gate of the reference current source, and a transistor drain of the reference current source is coupled to the transistor gate of the reference current source.

25. The pixel driver controller according to claim 18, further comprising a global brightness controller coupled to each of the current switches to adjust the current of the LED device.

26. The pixel driver controller according to claim 25, further comprising a test circuit coupled between the LED device and the global brightness controller.

27. A micro display back plane system, comprising:
a data interface configured to provide image data as frame data;
a display frame buffer coupled to the data interface to receive the frame data from the data interface frame by frame;
a column driver coupled to the display frame buffer to receive the frame data; and
a pixel driver controller array coupled to the column driver and configured to control pixels of a pixel display according to the frame data, at least one pixel driver controller of the pixel driver controller array comprising:
a reference current source, configured to supply a reference current;
a current mirror source, coupled to receive the reference current source, configured to provide a mirror current having a current value equal to a current value of the reference current; and
at least two current switches, each coupled to the current mirror source to receive the mirror current, each current switch being further coupled to an LED device to control flow of the mirror current to the LED device.

28. The micro display back plane system according to claim 27, further comprising an internal memory configured to store frame data, each of the current switches being coupled to the internal memory to control operation of the current switches according to the frame data.

29. The micro display back plane system according to claim 28, wherein a power-on status of each of the current switches corresponds to a state of conducting the mirror current, the power-on status of each of the current switches being determined by a gray scale value of the frame data;
wherein, a gray scale value of light emitted by the LED device is determined by the power-on status of each of the current switches.

30. The micro display back plane system according to claim 29, wherein the number of the current switches is determined by the gray scale value of the frame data, the gray scale value of the frame data being an integer multiple of the number of the current switches.

31. The micro display back plane system according to claim 29, wherein the gray scale value of the frame data is N bit, where N is a non-negative integer.

32. The micro display back plane system according to claim 31, wherein the value of N is 8, the number of the current switches is j, where j is an integer, and j=8/m, where m is a preset value that is 1, 2, 4, or 8.

33. The micro display back plane system according to claim 32, wherein a power-on time ratio of the current switches is 2^{(j-1)}:2^{(j-2)}: . . . :2⁰, when j is greater than 2; and the power-on time ratio of the current switches is 2^{(j-1)}:2⁰, when j equals to 2.

34. The micro display back plane system according to claim 29, further comprising a global brightness controller coupled to each of the current switches, to adjust the gray value of the LED device.

35. The micro display back plane system according to claim 34, further comprising a test circuit coupled between the LED device and the global brightness controller.

36. The micro display back plane system according to claim 27, further comprising an image enhancer, coupled to the display frame buffer to receive and sharpen an image represented by the frame data.

37. The micro display back plane system according to claim 36, comprising:
A one-time-programmable (“OTP”) memory coupled to the image enhancer and configured to determine a compensation value;
wherein, the image enhancer is coupled to receive the compensation value from the OTP memory and optimize the frame data by applying the compensation value to the received frame data, the image enhancer being coupled to transmit the optimized frame data to the column driver.

38. The micro display back plane system according to claim 37, wherein the OTP memory is coupled to the data interface and the display frame buffer to receive standard image data via the data interface and the frame data from the display frame buffer, the OTP memory being further configured to determine the compensation value by comparing the standard image data with the frame data received from the display frame buffer.

39. The micro display back plane system according to claim 27, comprising a power controller configured to control power for the back plane system.

40. The micro display back plane system according to claim 27, comprising a row driver coupled to the pixel driver controller array and configured to control row scanning of the pixels to turn pixels on or off.

41. The micro display back plane system according to claim 27, comprising a temperature sensor configured to detect temperature of the pixel driver controller array.

42. A micro display back plane system, comprising:
a data interface, configured to provide image data as frame data;
a display frame buffer coupled to the data interface to receive the frame data from the data interface frame by frame;
a column driver coupled to the display frame buffer to receive the frame data; and
a pixel driver controller array coupled to the column driver and configured to control pixels of a pixel display according to the frame data, at least one pixel driver controller of the pixel driver controller array comprising,
a reference current source configured to supply a reference current;
at least two current mirror circuits, each of the current mirror circuits comprising,
a current mirror source and a current switch, the current mirror source coupled in series to the current switch;
wherein the current mirror sources are configured to have respectively different current values; and each of the current switches is configured to control a power-on and power-off status of the corresponding current mirror circuit according to frame data; and
each current mirror circuit being further coupled to an LED device to control flow of the mirror current to the LED device.

43. The micro display back plane system according to claim 42, further comprising an internal memory configured to store frame data, each of the current switches being coupled to the internal memory to control operation of the current switches according to the frame data.

44. The micro display back plane system according to claim 42, wherein the current value of each current mirror sources is an integer multiple of the reference current value.

45. The micro display back plane system according to claim 44, wherein the current value of each of the current mirror source is 2n times of the reference current, where n is a non-negative integer.

46. The micro display back plane system according to claim 44, wherein the number of the current mirror sources is determined by a gray scale value of the frame data, the gray scale value of the frame data being an integer multiple of the number of the current mirror sources.

47. The micro display back plane system according to claim 44, wherein the gray scale value of the frame data is N bit, N is a non-negative integer.

48. The micro display back plane system according to claim 47 wherein the value of N is 8, the number of the current mirror sources is j, where j is an integer, and j=8/m, where m is a preset value that is 1, 2, or 4.

49. The micro display back plane system according to claim 48, wherein a current value ratio of the current mirror source is 2^{(j-1)}:2^{(j-2)}: . . . :2⁰, when j is larger than 2; and the current value ratio of the current mirror source is 2^{(j-1)}:2⁰, when j is 2.

50. The micro display back plane system according to claim 42, wherein a transistor gate of the each of the current mirror sources is coupled to a transistor gate of the reference current source, and a transistor drain of the reference current source is coupled to the transistor gate of the reference current source.

51. The micro display back plane system according to claim 44, further comprising a global brightness controller coupled to each of the current switches to adjust the current of the LED device.

52. The micro display back plane system according to claim 51, further comprising a test circuit coupled between the LED device and the global brightness controller.

53. The micro display back plane system according to claim 42, further comprising:
an image enhancer, coupled to the display frame buffer to receive and sharpen an image represented by the frame data.

54. The micro display back plane system according to claim 53, comprising:
a one-time-programmable (“OTP”) memory coupled to the image enhancer and configured to determine a compensation value;
wherein, the image enhancer is coupled to receive the compensation value from the OTP memory and optimize the frame data by applying the compensation value to the received frame data, the image enhancer being coupled to transmit the optimized frame data to the column driver.

55. The micro display back plane system according to claim 54, wherein the OTP memory is coupled to the data interface and the display frame buffer to receive standard image data via the data interface and the frame data from the display frame buffer, the OTP memory being further configured to determine the compensation value by comparing the standard image data with the frame data received from the display frame buffer.

56. The micro display back plane system according to claim 42, comprising a power controller configured to control power for the back plane system.

57. The micro display back plane system according to claim 42, comprising a row driver coupled to the pixel driver controller array and configured to control row scanning of the pixels to turn pixels on or off.

58. The micro display back plane system according to claim 42, comprising a temperature sensor configured to detect temperature of the pixel driver controller array.
